(19) United States
(12) Patent Application Publication
(10) Pub. No.: US 2005/0237705 A1
(43) Pub. Date: Oct. 27, 2005

(54) All-in-one personal computer and related methods

(76) Inventors: Raymond Moskaluk, San Jose, CA (US); Jerry Bennitt Ortkiese, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/831,590

(22) Filed: Apr. 22, 2004

(51) Int. Cl. G06F 1/16

(52) U.S. Cl. 361/683

(57) ABSTRACT

A multi-function personal computer apparatus includes a personal computer enclosed in a first housing, a multi-function peripheral unit enclosed in a second housing, a mechanical coupling device for mechanically coupling the first housing and the second housing together to form an integral unit, and an electrical coupling device for electrically coupling the personal computer and the multi-peripheral unit together. Alternately, the personal computer and the multi-function peripheral unit may be in the same housing. The personal computer and the multi-function peripheral unit may together form a portable unit.

### BACKGROUND

1. Field of the Invention

The present invention relates generally to computer apparatus. In particular, the present invention relates to an all-in-one personal computer and related methods for the functions thereof.

2. Prior Art

Many professionals work away from office facilities, moving from one location to the other to conduct their work. Company field agents, salesmen, insurance agents, real estate agents, and consultants all function primarily out of their automobile, in the field or in temporary offices. However, with the wide-spread utilization of computer systems, digital communications and data processing, it is essential to have computers and other electronic interface apparatus for such field professionals to conduct their business. Consequently, personal and portable computers have become necessary tools for company personnel in any location to obtain access to catalog and inventory databases, place orders and provide reports.

With the increased mobility of workers, laptop and notebook computers have proliferated. In many instances, such computers have access to the internet, email and fax messaging. However, ready access to mobile computer peripherals has not been as easy. Mini-printers have been developed for use with portable computers. In addition, many multi-function peripherals now exist that combine printing, copying, scanning, faxing and other functions in one machine. See, for example, U.S. Pat. No. 5,995,678. However, such machines are not readily portable for use in the field by mobile professional workers.

In addition, many small businesses do not have room for large computers or multiple function peripherals. Home offices are often cramped for space. Many small businesses in developing countries have little space or funds for large or complex computers and computer peripherals. Yet, it is important to have such electronic tools to interface with other offices and business personnel, vendors, customers and collaborators.

Furthermore, there are numerous specific needs for small shopkeepers and store owners that may be highly specialized and repetitive. For example, a small photo-shop may provide a few specific functions to the public, such as taking and developing passport photos, duplicating related paperwork and editing other documents, in connection with its passport related services. A small electronic processing unit having a computer connected to a scanner, fax, printer and copier would provide great versatility for such a shopkeeper to conduct his specialized business.

Accordingly, there is a need for a compact computer system, having a personal computer and computer peripherals, in a small, durable, lightweight, inexpensive unit that may be readily moved from place to place and that requires a small amount of power and little space.

### SUMMARY OF THE INVENTION

In one embodiment of the present invention, a multifunction personal computer apparatus is provided, comprising a personal computer enclosed in a first housing, a multi-function peripheral unit enclosed in a second housing, a mechanical coupling device for coupling the first housing and the second housing together to form an integral unit. An electrical coupling device electrically couples the multi-functional peripheral unit to the personal computer.

In another embodiment of the present invention, a method is provided comprising providing a personal computer in a first housing, providing a multi-functional peripheral unit in a second housing, mechanically coupling the first and second housings together, and electrically coupling the personal computer and the multi-functional peripheral unit.

### BRIEF DESCRIPTION OF THE DRAWINGS

FIG. 1 is a perspective view of a personal computer according one embodiment of the present invention;

FIG. 2 is a perspective exploded view of a multi-peripheral device according to one embodiment of the present invention being connected to the personal computer shown in FIG. 1;

FIG. 3 is a bottom plan view of the multi-peripheral device shown in FIG. 2;

FIG. 4 is another perspective view of the personal computer connected to the multi-peripheral device shown in FIG. 2;

FIG. 5 is a schematic diagram of the multi-peripheral device and personal computer shown in FIGS. 3 and 4;

FIG. 6 is a schematic diagram of a multiple peripheral devices and a personal computer in a single housing, according to another embodiment of the present invention;

FIG. 7 is a block diagram showing a functional relationship of one embodiment of the present invention; and

FIG. 8 is a block diagram showing a functional relationship of another embodiment of the present invention.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

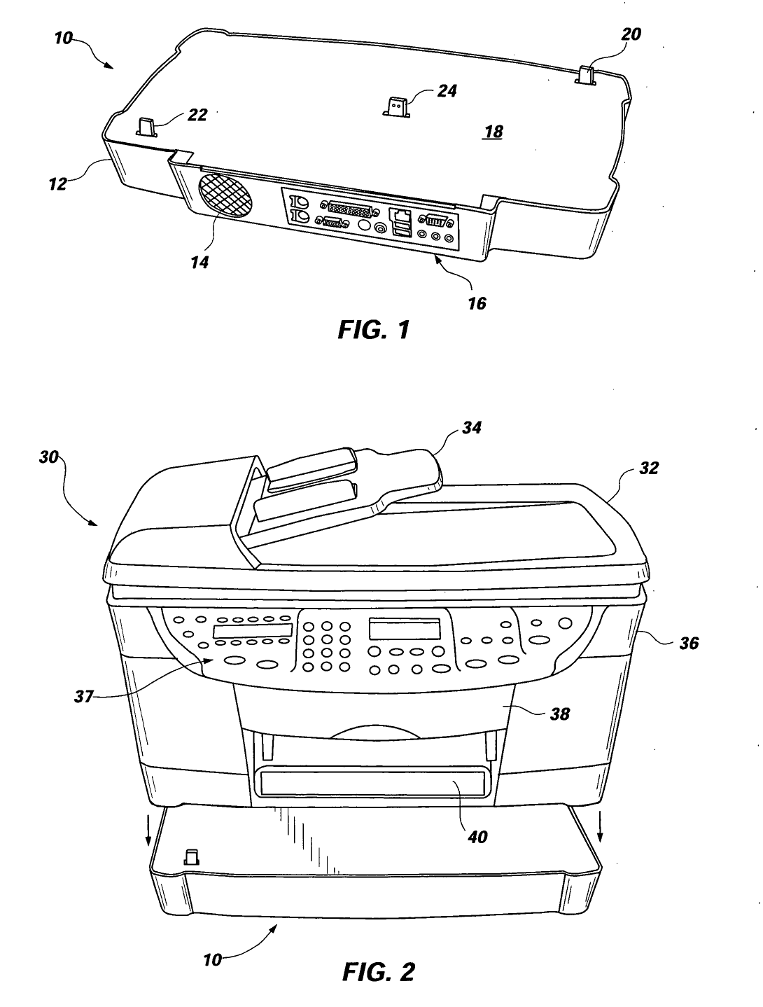

Looking now at FIG. 1, a perspective view is shown of a personal computer 10 disposed in a housing 12, according to one embodiment of the present invention. Housing 12 may be made of a rugged sturdy material such as metal to withstand being dropped, bumped and exposed to difficult conditions in the outdoors. A fan outlet 14 and multiple electrical inlets and outlets 16 are provided about the periphery of housing 12.

The top of housing 12 is a flat surface 18, adapted for coupling with another interfacing unit, as discussed below. Two interlocking pins 20 and 22 are disposed near opposite corners of surface 18 for connecting to the other unit. An electrical coupler 24 is disposed near the center of surface 18 for coupling electrically with another interfacing unit.

FIG. 2 shows a multi-functional peripheral (MFP) unit 30 having a plurality of peripheral units for interfacing with the personal computer 10. The exploded view shows the manner in which the MFP interfaces with the personal computer 10 to form an integral unit. The MFP unit 30 may include various peripheral devices (not shown), including a printer, a scanner, a copier, a facsimile machine and other peripheral devices. As used herein, the terms “multi-function unit,” “multi-function peripheral unit” or “MFP unit” means a unit having a plurality of peripheral devices, including but not limited to a printer, copier, scanner, fax machine, hub, router and modem.

A lid 32 may include a feeder 34 for providing documents to be processed by the MFP unit 30. A lower housing 36 is disposed below lid 32 with various selector buttons 37 thereon to determine the peripheral device being accessed and to input the functions being performed by each device. A paper tray 38 is shown, as well as a document outlet 40 near the bottom of MFP unit 30.

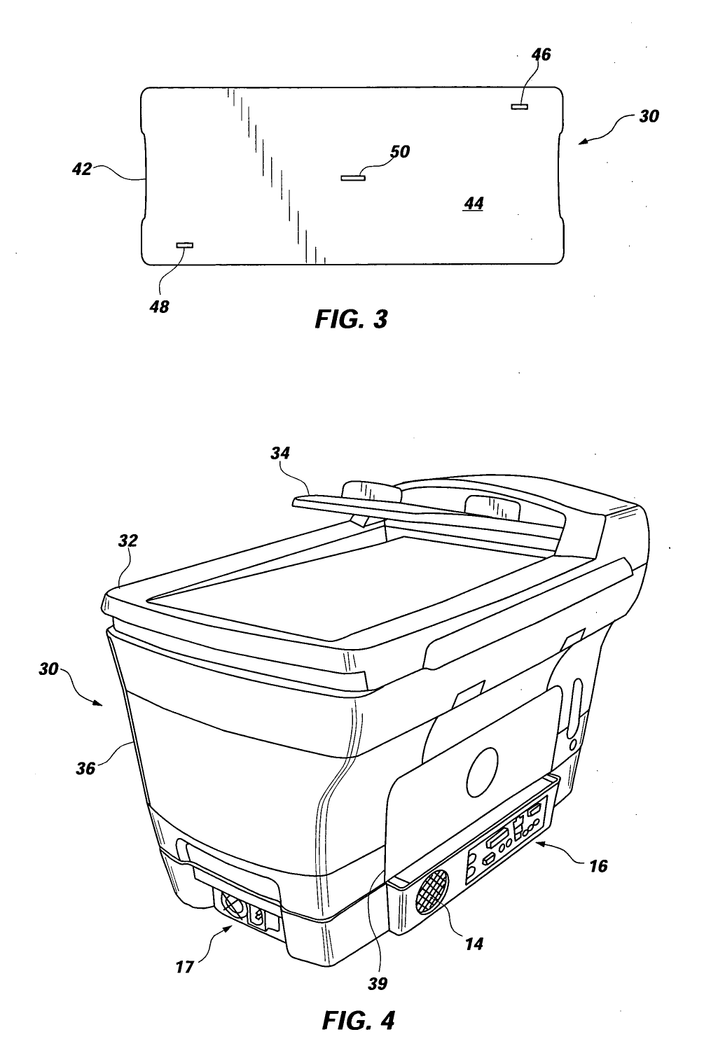

FIG. 3 shows the bottom 42 of MFP unit 30 having a flat surface 44 for releasably coupling with flat surface 18 of personal computer 10. Surface 44 includes two locking receptacles 46 and 48 formed at opposite corners of surface 44, so as to couple with interlocking pins 20 and 22 to hold personal computer 10 and MFP unit 30 together as an integral unit. An electrical receptacle 50 is disposed near the center of surface 44 for electrically coupling with electrical coupler 24 on the surface 18 of personal computer 10, as shown in FIG. 1. Coupler 24 and receptacle 50 may be USB connectors or other suitable electrical couplers. Receptacles 46, 38 and 50 are easily releasable from interlocking pins 20 and 22 and from coupler 24. As used herein, the terms “releasable” and “releasably” mean that the relevant coupling devices may be easily decoupled at will.

FIG. 4 shows another perspective view of the MFP unit 30 releasably coupled to personal computer 10 to form an integral unit. At the back of housing 36 is an access plate 39 for providing access to the peripheral devices therein. Additional connectors 17 are shown on one side of personal computer 10.

Although not show herein, a portable power supply may be added to personal computer 10 or MFP unit 30, as desired. Other peripherals, such as a modem and CD-ROM player and/or burner may be included.

It should be understood that, in an alternate embodiment (not shown), personal computer 10 and MFP unit 30 may be connected by using a mechanical coupling device to also establish an electrical coupling function between the personal computer and the MFP unit 30. Thus, in this embodiment, the electrical coupling device 24 shown in FIG. 1 would be omitted. Electrical coupling would occur through the locking pins 20 and 22 coupling with receptacles 46 and 48, shown in FIG. 3. In another alternative embodiment (not shown), personal computer 10 and MFP unit 30 may be electrically coupled together by suitable wires and cables running between the personal computer and the MFP unit 30.

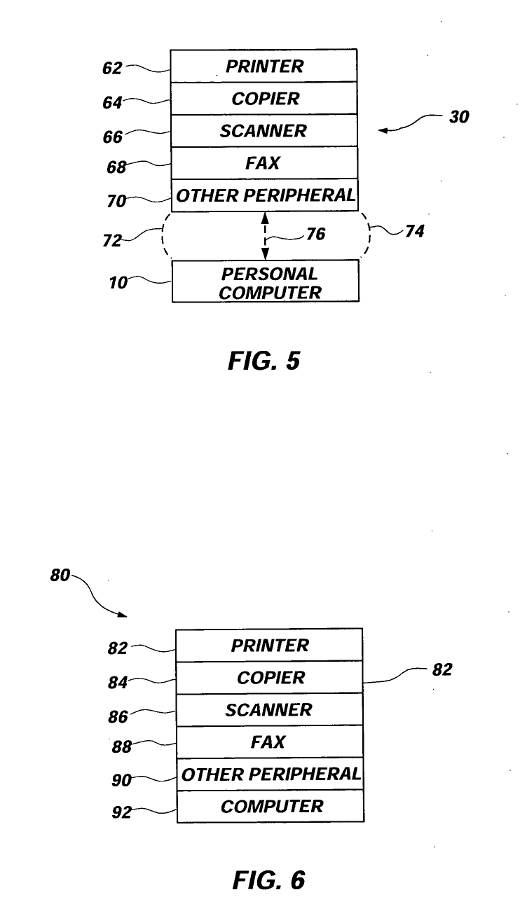

FIG. 5 shows a schematic diagram showing one possible arrangement of peripheral devices in the MFP unit 30. A printer 62, copier 64, scanner 66, fax machine 68 and other peripheral devices 70 are shown stacked on each other within the housing of MFP unit 30. It is understood that many other combinations of peripheral devices may be used within the scope of the present invention. The dotted lines 72 and 74 indicate that personal computer 10 may be mechanically coupled to MFP unit 30, and the dotted line 76 indicates that the personal computer 10 may be electrically coupled to MFP unit 30. Examples of such couplings are shown in FIGS. 1-4. The dotted lines 72, 74 and 76 further indicate that such electrical and mechanical couplings are releasable.

Suitable connecting wires (not shown) are provided to electrically couple the peripheral devices 62-70 with each other and with the personal computer 10. Such electrical coupling may be accomplished by means of electrical coupler 24 and electrical receptacle 50, shown in FIGS. 1 and 3, respectively. Alternately, the peripherals 62-70 may be electrically coupled with personal computer 10 by means of suitable wiring (not shown) extending from MFP unit to the electrical inlets and outlets 16 and 17, shown in FIGS. 1 and 4.

FIG. 6 depicts an alternate embodiment of the present disclosure in which multiple peripheral devices and a personal computer are disposed as a single unit 80 within a single integral housing 80. Peripheral devices in unit 80 may include a printer 82, a copier 84, a scanner 86, a fax machine 88 and other peripherals 90. Personal computer 92 is disposed within the same housing 80, rather than being in a separate housing to be coupled with a peripheral housing.

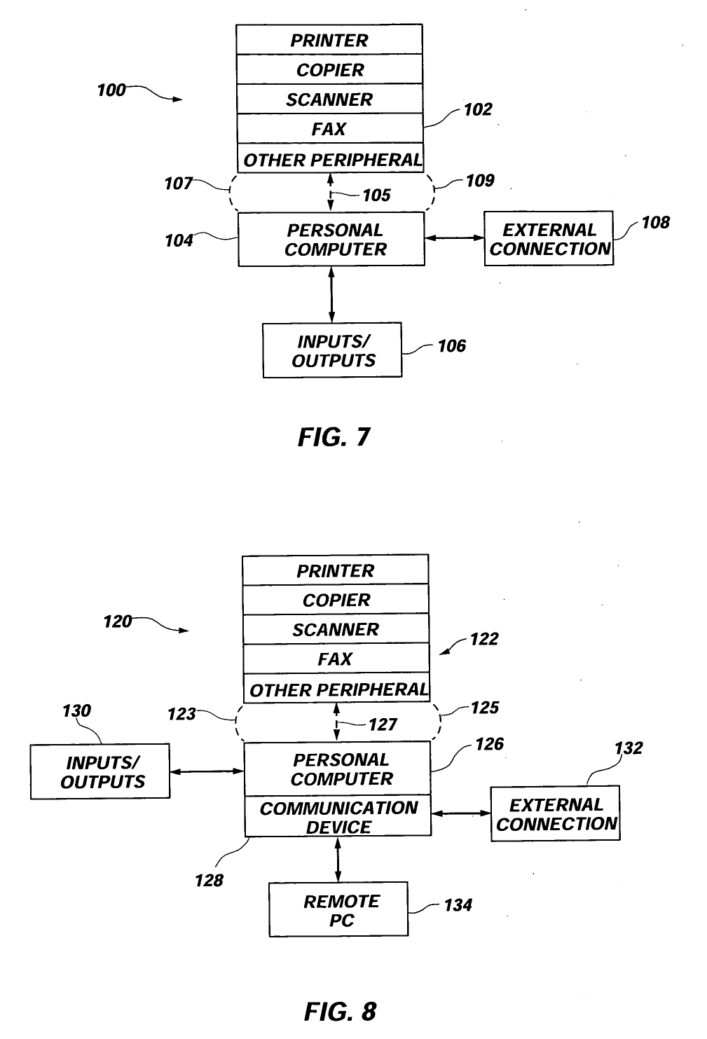

FIG. 7 shows a block diagram of a network 100 according to an embodiment of the present invention. Network 100 includes a multi-functional peripheral (MFP) unit 102, comprising a printer, copier, scanner, fax and other peripheral device, similar to MFP unit 30 shown in FIGS. 2-4. Dotted lines 107 and 109 indicate that MFP unit 102 is mechanically coupled to personal computer 104 by suitable coupling means. Dotted line 105 indicates that personal computer 104 is electrically coupled to MFP unit 102. As in FIG. 5, the electrical and mechanical couplings may be easily decoupled at will. Examples of such coupling are shown in FIGS. 1-4. Various inputs and outputs 106, such as a keyboard and a monitor, are coupled to the personal computer 104 in a conventional manner. An external connection 108 may be provided to couple to personal computer 104, as well other personal computers (not shown).

External connection 108 may have several conventional configurations. It may be a wired or wireless hub or router, a cable or DSL modem with or without a wired or wireless router or any other combination of external connections to other networks and computers.

FIG. 8 shows another block diagram of another network 120 according to another embodiment of the present invention. A multi-functional peripheral (MFP) unit 122, having multiple peripheral devices therein similar to those shown in FIGS. 5, 6 and 7, is releasably mechanically and electrically coupled to a personal computer 126, as shown by dotted lines 123, 125 and 127. A communication device 128 is built into the same housing as personal computer 126. Alternately the communication device 128 may be a separate unit mechanically and electrically coupled to personal computer 126. The communication device may be a hub, router, modem or any combination thereof. The communication device 128 may also be wired or wireless, and may be connected in any of several systems, including broadband, cable or DSL.

Personal computer 126 is coupled to suitable inputs and outputs 130, such as a keyboard and a monitor. Communication device 128 is electrically coupled to an external connection 132, having any of several convention connections, as mentioned above with respect to external connection 108 in FIG. 7. Communication device 128 may also be connected to one or more remote personal computers, by electrical wiring or by a wireless communication system. In this manner, a number of remote personal computers can gain access to the peripheral devices in MFP unit 122, by way of communication device 128 and personal computer 126.

As shown in the foregoing embodiments, a personal computer and multiple peripheral devices may be mechanically and electrically coupled together to form a single unit. This integral unit may also be small enough to be portable for a variety of uses. It may be a portable device carried into the field for usage by field agents, salesmen, maintenance men, insurance agents and real estate agents. Furthermore, the integral and compact nature of the unit is adaptable to small office, home use and other uses where there is little space for such devices. In addition, the compact nature of the units of the present invention provides the possibility of carrying the units in vehicles for temporary use at any desired site. Moreover, the compact and comprehensive nature of the units disclosed herein are readily used in network systems, particularly to provide ready access to multiple peripherals and file storage and sharing from remote computers acting through a central computer hub that is mechanically and electrically coupled to a peripheral unit according to the present invention.

It should be understood that many types of suitable mechanical couplers may be selected to couple the MFP unit 30 to personal computer 10 and to couple MFP unit 102 to personal computer 104. For example, clamping devices around the peripheries of the housing may be used. In addition, a variety of different electrical couplers may also be used within the scope of the present invention. Although the housings of the MFP units and personal computer units are shown as being generally rectangular, they may have any desired shape and still come within the scope of the present invention. Likewise, the personal computer may couple on top of the MFP unit or on the side thereof.

1. A multi-function personal computer apparatus, comprising:
(a) a personal computer enclosed in a first housing;
(b) a multi-function peripheral unit enclosed in a second housing;
(c) a mechanical coupling device for releasably mechanically coupling the first housing and the second housing together to form an integral unit; and
(d) an electrical coupling device for releasably electrically coupling the personal computer and the multi-peripheral unit together.

2. The apparatus of claim 1, wherein the multi-function peripheral unit comprises two or more devices selected from the following group: scanner, printer, copier, fax machine, hub, router and modem.

3. The apparatus of claim 1, wherein the personal computer apparatus is portable.

4. The apparatus of claim 1, wherein the mechanical coupling device comprises a first mechanical coupler associated with the first housing, and a second mechanical coupler associated with the second housing, the first and second mechanical couplers being adapted to mechanically mate together to secure the first and second housings as an integral unit.

5. The apparatus of claim 1, wherein the electrical coupling device comprises a first electrical coupler associated with the personal computer and a second electrical coupler associated with the multi-function peripheral unit, the first and second electrical coupling devices being adapted to electrically mate together when the first and second housings are couple together.

6. The apparatus of claim 1, wherein the mechanical coupling device is also the electrical coupling device.

7. The apparatus of claim 1, further comprising electrical coupling contacts on the first and second housings for electrically coupling the personal computer in the first housing to the multi-function peripheral unit in the second housing.

8. The apparatus of claim 1, further comprising electrical coupling contacts on the first housing for electrically coupling the personal computer to other peripheral equipment.

9. The apparatus of claim 1, further comprising a personal power device in the first or second housing for powering the integral unit.

10. A multi-function personal computer apparatus, comprising:
(a) a unitary housing;
(b) a personal computer enclosed in the unitary housing;
(c) a multi-function peripheral unit enclosed in the unitary housing; and
(d) an electrical coupling device for electrically coupling the personal computer and the multi-peripheral unit together to form one unit within the unitary housing.

11. The multi-function personal computer apparatus of claim 10, wherein the multi-function peripheral unit comprises two or more devices from the following group: printer, copier, scanner, fax machine, hub, router and modem.

12. The multi-function personal computer apparatus of claim 10, wherein the multi-function peripheral unit includes a hub or router to connect to other computers or networks.

13. The multi-function personal computer apparatus of claim 10, wherein the personal computer apparatus is portable.

14. A method for using a multi-function personal computer apparatus, comprising:
(a) providing a personal computer enclosed in a first housing;
(b) providing a multi-function peripheral unit enclosed in a second housing;
(c) releasably mechanically coupling the first housing and the second housing together to form an integral unit; and
(d) releasably electrically coupling the personal computer and the multi-peripheral unit together.

15. The method of claim 14, wherein providing a multi-function peripheral unit comprises selecting two or more devices from the following group: scanner, printer, copier, fax machine, hub, router and modem.

16. The method of claim 14, wherein the personal computer and the multi-functional peripheral unit are portable.

17. The method of claim 14, wherein the step of mechanically coupling the first and second housings comprises providing a first mechanical coupler associated with the first housing, and a second mechanical coupler associated with the second housing, the first and second mechanical couplers being adapted to mechanically mate together to secure the first and second housings as an integral unit.

18. The method of claim 14, wherein the step of electrically coupling the personal computer and the multifunction peripheral comprises providing a first electrical coupler associated with the personal computer and a second electrical coupler associated with the multi-function peripheral unit to electrically mate with the first electrical coupler.

19. The method of claim 14, wherein the steps of mechanically coupling and electrically coupling are performed by the same device.

20. The method of claim 14, wherein the step of electrically coupling the personal computer to the multi-peripheral unit is automatically performed as the step is performed of mechanically coupling the first housing to the second housing.

21. A network system, comprising:
(a) a system network hub or router for coupling to a plurality of computers;
(b) a personal computer disposed in a first housing;
(c) a multi-function peripheral unit disposed in a second housing;
(d) a mechanical coupling device for releasably mechanically coupling the first housing and the second housing together to form an integral unit; and
(e) an electrical coupling device for releasably electrically coupling the personal computer and the multi-peripheral unit together.

22. The network system of claim 21, wherein the electrical coupling device is coupled by coupling the first and second housings with the mechanical coupling device.

23. The network system of claim 22, wherein the mechanical coupling device and the electrical coupling device are the same device.

24. The network system of claim 22, wherein the mechanical coupling device and the electrical coupling device are on a common surface.

25. The apparatus of claim 21, wherein the multi-function peripheral unit comprises one or more devices selected from the following group: scanner, printer, copier, fax machine, router, hub and modem.

26. The apparatus of claim 21, further comprising electrical contacts on the personal computer for coupling the personal computer to a plurality of input and output devices.

27. The apparatus of claim 21, wherein the network hub or router is coupled to a plurality of computers by wired means.

28. The apparatus of claim 21, wherein the network hub or router is coupled to a plurality of computers by wireless means.

29. A network system, comprising:
(a) a personal computer disposed in a first housing;
(b) a system communication device disposed in the first housing electrically coupled to the personal computer for coupling the personal computer to a plurality of computers;
(c) a multi-function peripheral unit disposed in a second housing;
(d) a mechanical coupling device for mechanically coupling the first housing and the second housing together to form an integral unit; and
(e) an electrical coupling device for electrically coupling the personal computer and the multi-peripheral unit together.

30. The network system of claim 29, wherein the electrical coupling device is coupled by coupling the first and second housings with the mechanical coupling device.

31. The network system of claim 29, wherein the personal computer and the system communication device are mechanically coupled together.

32. The network system of claim 29, wherein the system communication device is selected from the following group: a modem, a hub or a router.

33. The network system of claim 32, wherein the system communication device is a broadband device.

34. The network system of claim 29, wherein the system communication device is electrically coupled by wireless means to the plurality of computers.

35. The network system of claim 29, wherein the system communication device is electrically coupled by wired means to the plurality of computers.
